(19) United States
(12) Patent Application Publication
(10) Pub. No.: US 2026/0225487 A1
(43) Pub. Date: Aug. 6, 2026

(54) SYSTEMS AND METHODS FOR OPTIMIZING VEHICLE CHARGING BY LOCATION TAGGING

(71) Applicant: Ford Global Technologies, LLC, Dearborn, MI (US)

(72) Inventors: Syam Chand Kamarajugadda, Machilipatnam (IN); Chen Zhang, South Lyon, MI (US); Xiaowu Zhang, Novi, MI (US); Albert Hu, Atlanta, GA (US)

(73) Assignee: Ford Global Technologies, LLC, Dearborn, MI (US)

(21) Appl. No.: 19/046,312

(22) Filed: Feb. 5, 2025

(51) Int. Cl. B60L 53/63; B60L 53/68

(52) U.S. Cl. CPC B60L 53/63; B60L 53/68; B60L 2240/622; B60L 2240/72; B60L 2260/50

(57) ABSTRACT

A location tagging and management system including a transceiver and a processor is disclosed. The transceiver may receive historical trip information and historical charging information associated with a vehicle. The processor may determine a primary location, from a plurality of locations, associated with the vehicle based on the historical trip information and the historical charging information. The plurality of locations may be historically visited by the vehicle. The processor may further determine a real-time utility power demand in a geographical area including the primary location, when the vehicle is located at the primary location. The processor may additionally compare the real-time utility power demand with a predefined demand threshold, and perform a predefined action when the real-time utility power demand is greater than the predefined demand threshold.

### FIELD

The present disclosure relates to systems and methods for optimizing vehicle charging by identifying and tagging a vehicle's primary location, a primary charging location and a primary parking location.

### BACKGROUND

Electric Vehicles (EVs) require regular charging at EV charging stations to ensure optimal vehicle operation. As the EV adoption increases, the number of EVs has increased considerably, resulting in a surge of demand for charging solutions/stations. As the number of EVs is steadily increasing, the rate of growth of charging stations needs to match the EV charging needs so that users do not face inconvenience in identifying available charging stations for vehicle charging. Consequently, it is important that charging infrastructure firms install an optimal number of chargers at locations where the demand for vehicle charging is expected to be high.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example process for identifying and tagging a vehicle primary location in accordance with the present disclosure.

FIG. 3 depicts an example graph illustrating a plurality of parking events of a vehicle with time in accordance with the present disclosure.

FIGS. 4A and 4B depict an example process for tagging a vehicle's home location and work location, and charger types used by a vehicle for charging in accordance with the present disclosure.

FIG. 5 depicts a flow diagram of an example method for optimizing vehicle charging based on a vehicle's primary location in accordance with the present disclosure.

### DETAILED DESCRIPTION

### Overview

The present disclosure describes a location tagging system and method for identifying one or more primary locations associated with a vehicle, and optimizing vehicle charging experience for a vehicle user based on the identified primary location(s). The primary locations associated with the vehicle may be a primary parking location, a primary charging location and an overall primary location for the vehicle. The primary parking location may be a location where the vehicle may have historically parked for a highest time duration or for a highest count of times. Similarly, the primary charging location may be a location where the vehicle may have historically charged for a highest time duration or for a highest count of times. The overall primary location may be a location where the vehicle may have historically parked and/or charged for the highest time duration and/or for a highest count of times. The primary parking and charging locations and the overall primary location may be the same or different for a vehicle.

The system may share information associated with the identified primary locations for a plurality of vehicles with a charger management firm, which may use the information to estimate the vehicle charging demand in one or more geographical areas including the identified primary locations and accordingly plan to install newer chargers (e.g., in an area that has a lot of primary locations). In some aspects, the charger management firm may be a charge point operator (CPO), a government office that focuses on site planning for public charging, or any other stakeholder. The system may further use the information associated with the identified primary locations for a vehicle to recommend optimal vehicle charging strategies to the vehicle user, to enhance the charging experience for the user.

In some aspects, to identify the primary locations for a vehicle, the system may first obtain historical trip information and historical charging information associated with the vehicle. The system may then identify the primary parking location for the vehicle based on the historical trip information. Similarly, the system may identify the primary charging location for the vehicle based on the historical charging information. The primary parking location may or may not be same as the primary charging location.

The system may additionally identify a primary park confidence level associated with each of the plurality of locations where the vehicle may have historically visited/parked, and a primary plug confidence level associated with each of the plurality of locations where the vehicle may have historically charged the vehicle. The system may then calculate a primary confidence level associated with each of the plurality of locations based on the primary park confidence level and the primary plug confidence level. The system may further identify the primary location for the vehicle as the location that has the highest primary confidence level.

Responsive to determining the primary location for the vehicle, in one exemplary aspect, the system may monitor a real-time utility power demand in a geographical area including the primary location whenever the vehicle is located at the primary location. The system may perform a predefined action when the vehicle is located at the primary location and the real-time utility power demand (and hence the energy pricing) is greater than a predefined demand threshold. Examples of the predefined action include, but are not limited to, transmitting a command signal to the vehicle to autonomously move the vehicle to a second location (where the energy demand/pricing may be low) that is different from the primary location, outputting a first notification including a request to move the vehicle to the second location, outputting a second notification including one or more incentives to be offered to the vehicle user when the vehicle user moves the vehicle to the second location, outputting a third notification including a request to not charge the vehicle at the primary location at a current time (when the energy pricing is high), outputting a command signal to the vehicle plugged in at the primary location to automatically stop charging during windows of high energy demand and resume the charging outside of the windows of high energy demand, and/or the like. In further aspects, the system may output a notification to a server associated with the charger management firm, requesting the firm to install one or more new or additional chargers at the primary location (e.g., to cater to the high vehicle charging demand, if the high demand is consistent for a relatively long time duration).

The system may additionally tag the identified primary location as home location, work location, and/or the like, based on the historical trip information. The system may also tag the chargers used for vehicle charging as AC chargers, DC chargers, private chargers, public chargers, etc., based on the historical charging information.

The present disclosure discloses a location tagging system and method that may facilitate charger management firms to identify locations where newer chargers may be installed. The system may additionally facilitate a vehicle user to charge the vehicle optimally and at a lower pricing at locations that may be different from the vehicle's primary location, e.g., when the energy pricing at the primary location may be high.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

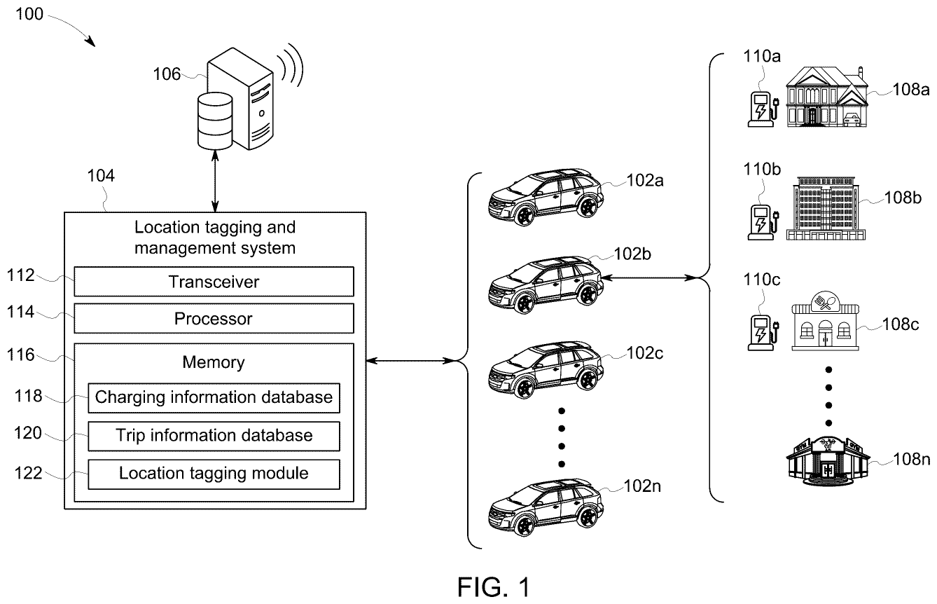

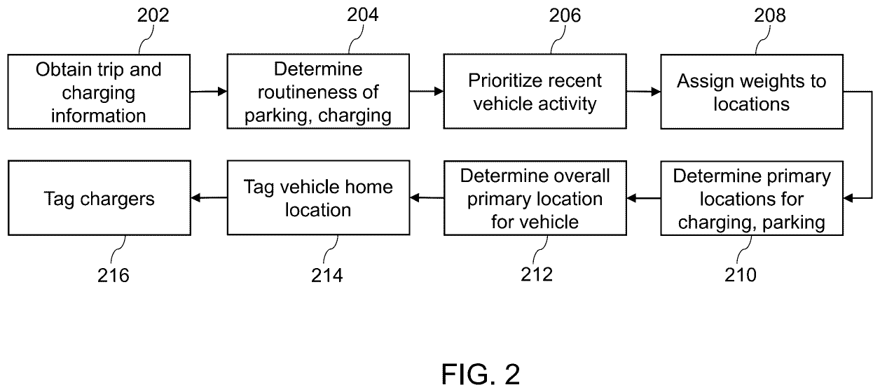

FIG. 1 depicts an example environment 100 in which techniques and structures for providing the systems and methods disclosed herein may be implemented. FIG. 1 will be described in conjunction with FIGS. 2, 3, 4A and 4B.

The environment 100 may have include a plurality of vehicles 102a, 102b, 102c, 102n (collectively referred to as vehicles 102). Each vehicle 102 may take the form of any passenger or commercial vehicle, for example, a car, a work vehicle, a crossover vehicle, a truck, a van, a minivan, a taxi, a bus, etc. The vehicle 102 may be a manually driven vehicle and/or may be configured to operate in a partially or fully autonomous mode. In an exemplary aspect, each vehicle 102 may be an Electric Vehicle (EV).

The environment 100 may further include a location tagging and management system 104 (or system 104) and one or more servers 106 (or a server 106). The server 106 may store historical trip information and historical charging information associated with each vehicle 102. In some aspects, the historical trip information associated with each vehicle 102 may include location information of a plurality of locations 108a, 108b, 108c, 108n (collectively referred to as plurality of locations 108) that the vehicle 102 may have visited in the past and/or where the vehicle 102 may have historically parked, a count of times the vehicle 102 was parked at each location 108, time durations for which the vehicle 102 was parked at each location 108, and/or the like. The server 106 may receive such information directly from each vehicle 102, and store the received information as “trip information”. In an exemplary aspect, the location information of the plurality of locations 108 is identified based on historical Global Positioning System (GPS) information associated with the vehicles 102 that the server 106 periodically receives from the vehicles 102.

The historical charging information associated with each vehicle 102 may include charging location information of one or more charging locations, from the plurality of locations 108, at which the vehicle 102 may have historically charged, a count of times the vehicle 102 was charged at each charging location, charging time durations of the vehicle 102 at each charging location, and/or the like. As may be appreciated, chargers 110a, 110b, 110c (collectively referred to as chargers 110) may or may not be present at each location 108, and consequently, not all the vehicle's parking locations 108 may be the same as the vehicle's charging locations. For example, as shown in FIG. 1, the locations 108a, 108b, 108c may have the chargers 110a, 110b, 110c, and hence the locations 108a, 108b, 108c may be the vehicle's parking locations as well as the vehicle's charging locations (if the vehicle 102 charged at these locations). On the other hand, since the location 108n does not have a charger (or the vehicle 102 may not have historically charged at the location 108n), the location 108n may be the vehicle's parking location but may not be a vehicle's charging location.

In additional or alternative aspects, the server 106 may be associated with a utility power grid, and may monitor and store information associated with real-time utility power demand in a plurality of geographical areas. In yet another aspect, the server 106 may be associated with a charger management firm that may install chargers (e.g., the chargers 110) at different locations in the plurality of geographical areas. In some aspects, the charger management firm may be a charge point operator (CPO), a government office that focuses on site planning for public charging, or any other stakeholder.

The system 104 may be communicatively coupled with the vehicles 102, the chargers 110, the server(s) 106, and/or the like, via one or more network(s). The network(s), as described here, may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the system 104 may be configured to identify one or more “primary” locations associated with each vehicle 102 based on vehicle's respective historical trip and/or charging information, and facilitate utility power grid firms and/or charger management firms to optimize vehicle charging experience for the vehicle owners. For example, the system 104 may identify a primary charging location, a primary parking location, and an overall primary location associated with each vehicle 102, and use this primary location information to recommend optimal locations where new chargers may be installed by the charger management firms and/or recommend optimal locations where the vehicle owners may be charge their vehicles if the real-time utility power demand (and hence the energy pricing) is high at their respective primary locations.

In an exemplary aspect, the primary parking location for a vehicle 102 may be a location where the vehicle 102 historically parked for a highest time duration or for a highest count of times. Similarly, the primary charging location for a vehicle 102 may be a location where the vehicle 102 historically charged for a highest time duration or for a highest count of times. The overall primary location associated with a vehicle 102 may be a location where the vehicle 102 may have historically parked and/or charged for the highest time duration or for a highest count of times. In some aspects, the primary charging location, the primary parking location and the overall primary location associated with a vehicle 102 may be the same. In other aspects, the primary charging location, the primary parking location and the overall primary location associated with a vehicle 102 may be different. For example, a vehicle 102 may have the primary parking location as the location 108a (which may also be the vehicle's overall primary location) and the primary charging location as the location 108c. As another example, the vehicle 102 may have the primary parking location, the primary charging location and the overall primary location same as the location 108a.

The system 104 may be hosted on a server or a distributed computing system, and may include a plurality of components including, but not limited to, a transceiver 112, a processor 114 and a memory 116. The transceiver 112 may receive/transmit data/information/signals from/to external systems and devices via the network(s) described above. For example, the transceiver 112 may receive the historical trip information and the historical charging information associated with each vehicle 102 from the server 106. The transceiver 112 may further receive information associated with real-time utility power demand in one or more geographical areas from the server 106. The transceiver 112 may additionally transmit command signals, information, data, etc. to the vehicles 102, the server(s) 106, and/or the like, via the network(s).

The processor 114 may be disposed in communication with one or more memory devices disposed in communication with the respective computing systems (e.g., the memory 116 and/or one or more external databases not shown in FIG. 1). The processor 114 may utilize the memory 116 to store programs in code and/or to store data for performing aspects in accordance with the disclosure. The memory 116 may be a non-transitory computer-readable storage medium or memory storing program codes that may enable the processor 114 to perform operations as per the present disclosure. The memory 116 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 116 may include a plurality of databases and modules including, but not limited to, a charging information database 118, a trip information database 120 and a location tagging module 122. The charging information database 118 may store the historical charging information for the vehicles 102 that the system 104 may receive from the server 106. Similarly, the trip information database 120 may store the historical trip information for the vehicles 102. The location tagging module 122 may be stored as computer executable instructions in the memory 116, which may be executed by the processor 114 to perform one or more operations as described in the present disclosure.

An example process implemented by the system 104/processor 114 to identify one or more primary locations associated with each vehicle 102 and facilitate the utility power grid firms and/or the charger management firms to optimize vehicle charging experience for the vehicle owners is depicted in FIG. 2 and described below.

At a first step 202, the processor 114 may obtain the historical trip information and the historical charging information associated with each vehicle 102 from the server 106 or directly from the vehicles 102, via the transceiver 112. In some aspects, the processor 114 may obtain the historical trip information and the historical charging information for a predefined historical time duration, which may be, for example, 3 months, 6 months, 12 months, and/or the like. In one exemplary aspect, the predefined historical time duration may be of at least 8 weeks. In further aspects, the historical trip information and the historical charging information may include data of at least 8 weeks with regular visits (meaning visits once a week on an average) to at least one location for 6 weeks. In additional aspects, for newer vehicles that may not have 8 weeks of data, the historical trip information and the historical charging information may include data with regular visits (meaning visits once a week on an average) to at least one location for 4 weeks.

The examples of the historical trip information and the historical charging information described above should not be construed as limiting. The historical trip information and the historical charging information may be in any other form and/or may be for a different historical time duration, without departing from the present disclosure scope.

Responsive to obtaining the information described above, the processor 114 may clean the obtained information (e.g., remove anomalies, outliers, etc.) at the first step 202. Furthermore, responsive to obtaining (and cleaning) the information described above, at a second step 204, the processor 114 may determine routineness of parking and charging for each vehicle 102 based on the historical trip information and the historical charging information. Specifically, at this step, the processor 114 may determine those locations 108 where the vehicle 102 may have parked and/or charged, and which may be potential “contenders” for primary parking location, primary charging location and/or overall primary location for the vehicle 102, based on the obtained historical trip and charging information. As an example, at this step, the processor 114 may include those locations as potential contenders for primary locations for the vehicle 102 where the vehicle 102 visited regularly, once a week on an average, for a span of at least 6 weeks (or 4 weeks for newer vehicles), and should not have more than 4 weeks of inactivity at those locations, since the last parking time of the vehicle 102.

In this manner, at the second step 204, the processor 114 may determine one or more potential contenders for primary locations (or “first locations”) for the vehicle 102 from the plurality of locations 108, based on the historical trip and/or charging information. The parking frequencies associated with the vehicle 102 may be greater than a predefined threshold on these first locations or contender locations, from where the primary locations will be identified by the processor 114 as described later in the description below. As described above, the predefined threshold may be once a week. Stated another way, the vehicle 102 should have parked and/or charged at a location for an average of at least once a week (for 4 or 6 weeks) for the location to be considered as one of the first locations or contender locations.

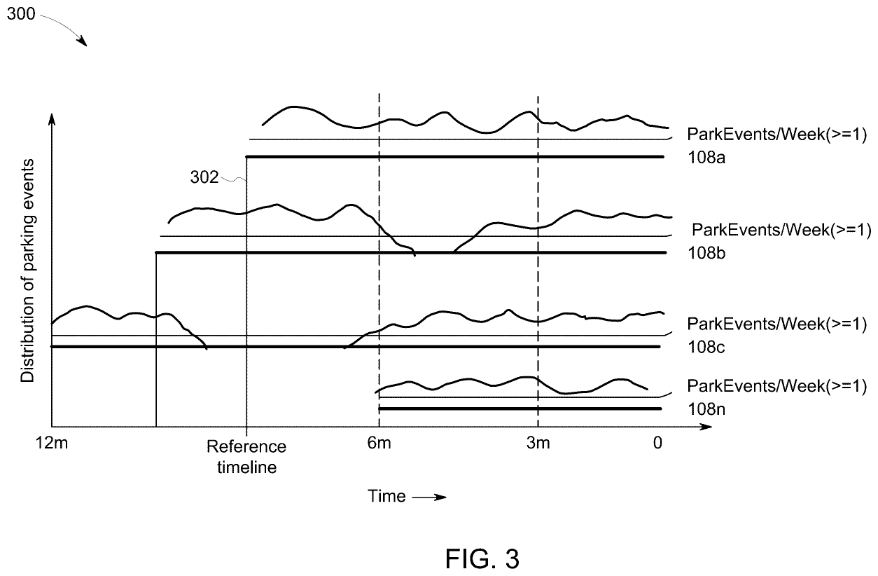

At a third step 206, the processor 114 may prioritize recent vehicle activity, e.g., to account for the change in vehicle's parking and/or charging locations due to vehicle owner's shifting from one place to another, and/or to account for vehicle activity during vacations. The processor 114 may perform this step by giving relatively higher priorities to recent vehicle activity compared to historical vehicle activity, and setting-up thresholds for a location to be considered for a primary location tag. In an exemplary aspect, at this step, the processor 114 may setup a reference timeline, which would be a common timeline during which the vehicle 102 made trips to all significant locations (e.g., the first locations described above). Responsive to setting-up the reference timeline, the processor 114 may ignore or not factor-in vehicle activity before the reference timeline. Stated another way, the processor 114 may not consider locations that the vehicle 102 visited before the reference timeline as contenders for primary locations for the vehicle 102. An example of a reference timeline 302 is depicted in a graph 300 of FIG. 3.

The graph 300 depicts a distribution of parking events (in Y-axis) associated with a vehicle 102 against time (in X-axis). In this case, as depicted in the graph 300, the processor 114 may obtain the historical trip information for the vehicle 102 for the past 12 months, in which the vehicle 102 may have visited and parked at the locations 108a, 108b, 108c and 108n. The processor 114 may set the reference timeline 302 (between 6 months and 12 months' time duration, as shown in the graph 300) after which the vehicle 102 made the trips to the locations 108a, 108b, 108c and 108n. Furthermore, in the exemplary aspect depicted in FIG. 3, the vehicle 102 may have parked at the locations 108a, 108b and 108c with a parking frequency of more than one per week, and may have parked at the location 108n with a parking frequency of less than one per week. Consequently, in this case, the processor 114 may not consider the location 108n as one of the first locations or contender locations (i.e., a location in contention for a primary location tag).

Responsive to setting-up the reference timeline 302 as described above, at a fourth step 208, the processor 114 may assign weights to vehicle activity or locations, based on the activity's timeline. The processor 114 may assign the weights such that recent vehicle activity (i.e., parking and/or charging at the first locations) is given higher weightage than relatively older vehicle activity. The process of assigning weights to locations is described above. The description below should not be construed as limiting.

In some aspects, the processor 114 may first cluster the vehicle trips (including parking and/or charging events) into clusters of trips based on the density and how close are the trips to each other. The centroid of the clusters may be used as the addresses for the first or contender locations 108a, 108b, 108c, etc. For example, the processor 114 may cluster parking activity (which may be the number of parking instances in a location and the total parking duration in the location) and charging or plug-in activity (which may be the number of plug-in instances in the location and the total plug-in duration in the location) at each contender location, based on timeline. Thereafter, the processor 114 may normalize the clusters by multiplying weights based on time-buckets to get a single weighted normalized metric for a location. The example weights are depicted in the table below.

| | 0-3 | 6-3 | Prior to |
|---|---|---|---|
| Span of data (trips to a location) | months | months | 6 months |
| Trips span < 3 months | 1 | 0 | 0 |
| 3 months < Trips span <= 6 months | 0.6 | 0.4 | 0 |
| Trips span > 6 months | 0.5 | 0.3 | 0.2 |

The processor 114 may then use the normalized “weighted” data for each location 108a, 108b, 108c to identify the primary charging location, the primary parking location and the overall primary location for the vehicle 102, as described below.

Responsive to normalizing the data for the locations 108a, 108b, 108c, the processor 114 may determine a first total time duration (“weighted” or “normalized” time duration) for which the vehicle 102 was parked at each of these locations and a first count of times (“weighted” or “normalized” count of times) the vehicle 102 was parked at each of these locations (e.g., based on the weighted or normalized historical trip information). Thereafter, the processor 114 may execute the instructions stored in the location tagging module 122 to determine/calculate a primary park confidence (PPC) level associated with each of the locations 108a, 108b, 108c based on the first total time duration and the first count of times. An example mathematical expression for PPC of each location is illustrated below, which should not be construed as limiting.

PPC=0.6 (PPD)+0.4 (PPI); where Primary Park Duration (PPD)=1 if the location is top for parking duration amongst the locations 108a, 108b, 108c and 0 otherwise, and Primary Park Instances (PPI)=1 if the location is top for parking instances and 0 otherwise.

In a similar manner, the processor 114 may determine a second total time duration (“weighted” or “normalized” time duration) for which the vehicle 102 was charged at each of the locations 108a, 108b, 108c and a second count of times (“weighted” or “normalized” count of times) the vehicle 102 was charged at each of these locations (e.g., based on the weighted or normalized historical charging information). In some aspects, the processor 114 may determine the second total time duration and the second count of times only when the processor 114 has enough historical trip and/or charging information (e.g., for at least 8 weeks or more). This is because for newer vehicles, the parking information may still be available and hence the processor 114 may determine with relative accuracy the first total time duration and the first count of times described above; however, the charging information may not available in abundance and hence it may not be possible for the processor 114 to accurately determine the second total time duration and the second count of times.

Responsive to determining the second total time duration and the second count of times (e.g., if enough historical trip and/or charging information is available), the processor 114 may execute the instructions stored in the location tagging module 122 to determine/calculate a primary plug confidence (PPGC) level associated with each of the locations 108a, 108b, 108c based on the second total time duration and the second count of times. An example mathematical expression for PPGC of each location is illustrated below, which should not be construed as limiting.

PPGC=0.6 (PPGD)+0.4 (PPGI); where Primary Plug Duration (PPGD)=1 if the location is top for plug-in/charging duration amongst the locations 108a, 108b, 108c and 0 otherwise, and Primary Plug Instances (PPGI)=1 if the location is top for plug-in/charging instances and 0 otherwise.

At a fifth step 210, the processor 114 may determine a primary parking location and/or a primary charging or plug-in location for the vehicle 102 based on PPC and/or PPGC respectively for each of the locations 108a, 108b, 108c (and hence based on the historical trip information and/or the historical charging information respectively for the vehicle 102). In some aspects, the primary parking location may be that location from the locations 108a, 108b, 108c which may have the highest PPC. Similarly, the primary charging or plug-in location may be that location from the locations 108a, 108b, 108c which may have the highest PPGC. As described above, the primary parking location may be the same as or different from the primary charging or plug-in location.

The processor 114 may further determine an overall primary location (from the locations 108a, 108b, 108c) for the vehicle 102 based on PPC and PPGC associated with each location 108a, 108b, 108c, at a sixth step 212. Specifically, at this step, the processor 114 may first calculate a primary confidence (PC) level associated with each of the locations 108a, 108b, 108c based on PPC and/or PPGC for each location. An example mathematical expression for PC of each location is illustrated below, which should not be construed as limiting.

$$PC = 0.6 ( PPGC ) + 0.4 ( PPC ) .$$

Responsive to calculating PC for each of the locations 108a, 108b, 108c, the processor 114 may determine the overall primary location for the vehicle 102 based on PC. In an exemplary aspect, the processor 114 may determine that location as the overall primary location for the vehicle 102 which may have the highest PC amongst the PCs of the 108a, 108b, 108c.

It may be appreciated that for newer vehicles (or for ICE vehicles), enough historical charging information may not be available. For such vehicles, the parking activity alone (and hence the historical trip information alone) may be used to identify the overall primary location, and no charging activity may be considered (and hence PPGC associated with each location 108a, 108b, 108c may be zero). In this case, PC=0.4 (PPC). Further, in this case, to discriminate locations in above scenarios (where information availability is low) to efficiently determine the primary location, the processor 114 may set/define a minimum amount of difference in the parking activity between primary and second primary locations. An example process to determine the primary location for the vehicle 102 when the information availability is low is described below.

Responsive to determining PC for each location 108a, 108b, 108c (here, PC=0.4 (PPC), as PPGC is zero), the processor 114 may determine a first potential candidate location from the locations 108a, 108b, 108c such that the PC associated with the first potential candidate location is highest amongst the PCs associated with the locations 108a, 108b, 108c. The processor 114 may additionally determine a second potential candidate location from the locations 108a, 108b, 108c such that the PC associated with the second potential candidate location is second highest amongst the PCs associated with the locations 108a, 108b, 108c.

The processor 114 may then calculate a first difference between a count of times the vehicle 102 was parked (or parking frequency) at the first potential candidate location and a count of times the vehicle 102 was parked at the second potential candidate location based on the historical trip information. The processor 114 may additionally calculate a second difference between a total time duration the vehicle 102 was parked at the first potential candidate location and a total time duration the vehicle 102 was parked at the second potential candidate location based on the historical trip information.

The processor 114 may select the first potential candidate location to be the primary location for the vehicle 102 when the first difference is greater than a first predefined threshold (which may be, e.g., 30% of the count of times the vehicle 102 was parked at the first potential candidate location) and the second difference is greater than a second predefined threshold (which may be, e.g., 50% of the total time duration the vehicle 102 was parked at the first potential candidate location). It may be appreciated that the processor 114 may implement the process described above to ensure that the primary location is accurately determined, especially when the information availability is low and hence the probability of incorrect identification of primary location is high.

Responsive to determining the primary location for the vehicle 102 as described above, the processor 114 may transmit the information associated with the identified primary locations and the corresponding confidence levels to the server 106 for storage purpose and/or for further processing at the server 106. The processor 114 may additionally determine a real-time utility power demand in a geographical area including the primary location (based on the information obtained from the server 106), whenever the vehicle 102 is located at the primary location. The processor 114 may then compare the real-time utility power demand with a predefined demand threshold, and perform a predefined action when the real-time utility power demand is greater than the predefined demand threshold. Stated another way, the processor 114 may perform the predefined action whenever the vehicle 102 is located at the primary location (e.g., the overall primary location, or the primary location for parking or charging) and the real-time utility power demand is high.

The processor 114 may perform the predefined action to optimize the vehicle charging experience. Examples of the predefined action include, but are not limited to, transmitting a command signal to the vehicle 102 to autonomously move the vehicle 102 to a second location that may be different from the primary location (so that the vehicle 102 may be charged at a location that may have lower real-time utility power demand, and hence lower energy pricing), outputting a first notification to the vehicle 102 and/or a user device associated with a vehicle user including a request for the vehicle user to move the vehicle 102 to the second location, outputting a second notification including one or more incentives (e.g., discounts, free meals, etc.) to be offered to the vehicle user when the vehicle user moves the vehicle 102 to the second location, outputting a third notification including a request to the vehicle user to not charge the vehicle 102 at the primary location at the current time (e.g., during peak time), outputting a command signal to the vehicle 102 plugged in at the primary location to automatically stop charging during windows of high energy demand and resume the charging outside of the windows of high energy demand, and/or the like.

In further aspects, the predefined action may include outputting a notification to the server 106 associated with a charger management firm, including a request to install one or more new chargers at the primary location. In this case, the charger management firm may monitor such requests for a specific location for a predefined time duration (e.g., for 2-3 months), and thereafter install new chargers at the primary location (or the geographical area including the primary location) if the server 106 receives such requests consistently for the primary location (indicating consistent high demand for vehicle charging at and/or around the geographical area including the primary location).

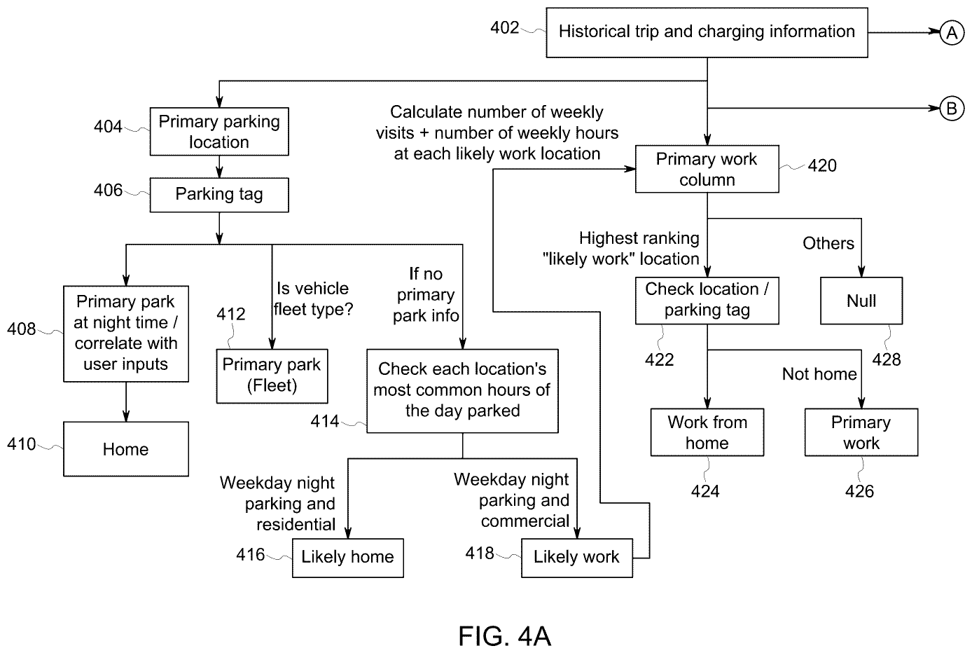

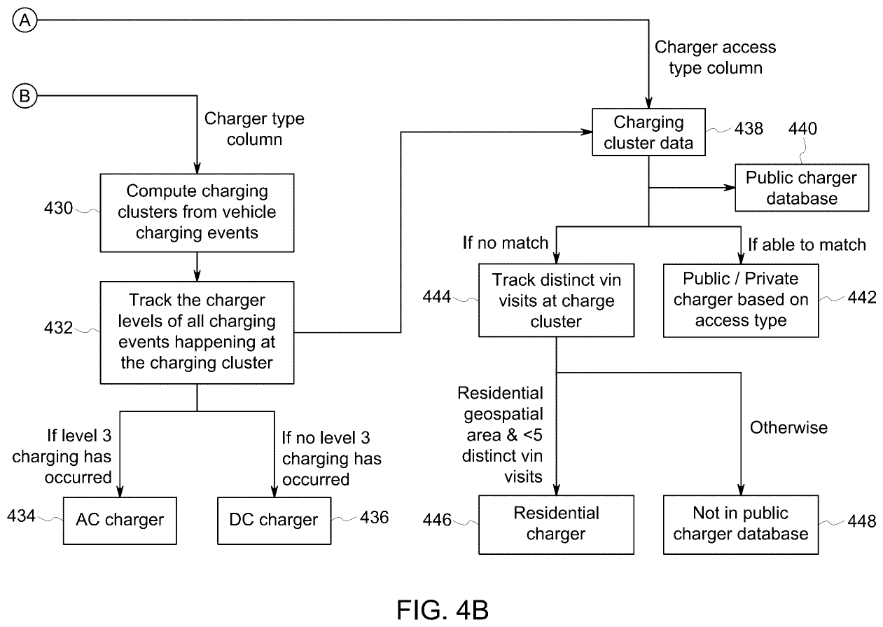

The processor 114 may perform one or more additional operations to further enhance the efficiency and accuracy of determining the primary location(s) associated with the vehicle 102. Examples of such additional operations are depicted as steps 214 and 216 in FIG. 2 and as an example process 400 in FIGS. 4A and 4B, which are described below.

As described above, the primary locations for parking, charging, and the overall primary location for the vehicle 102 could be different as the vehicle 102 may be located more frequently at the office but for longer hours at home (and may use public charging ports for vehicle charging). In this scenario, the most-used public charging location may become the primary location for charging, and either the office or home may become the primary location for parking. Further, the overall primary location may depend on the proportion of activity at these two locations (home or office).

At a seventh step 214, the processor 114 may tag the vehicle's home location, work/office location, and/or the like, to further enhance the system's primary location identification process. Specifically, at this step, the processor 114 may first obtain user inputs associated with a home location of the vehicle 102. As may be appreciated, at the time of vehicle purchase, users typically provide a purchase address that may be the user's home address. The processor 114 may obtain this user input (e.g., from the server 106) to estimate the vehicle's home address. The processor 114 may then correlate the identified primary location with the home location/address based on the user inputs. The processor 114 may determine that the primary location is identified with high accuracy if the identified primary location matches with the home location/address. In this case, the processor 114 may tag the identified primary location as the vehicle's home location.

In some aspects, if the home location/address is not provided by the user, the processor 114 may use the user or vehicle's parking behavior at the primary location to determine whether it can be classified as a home location or not. It may be appreciated that majority of home parking happens overnight, so the processor 114 may check a user's historical parking behavior at the primary location and if the processor 114 identifies that majority of the parking happens overnight at the primary location, the processor 114 may classify that primary location as the home location for the vehicle 102.

In further aspects, for vehicles without a primary location, the processor 114 may leverage the geospatial dataset which details if a road area is in a “commercial” or “residential” area to help determine possible vehicle's home location.

An example process implemented by the processor 114 to tag a primary location as home, work, etc. is depicted in FIGS. 4A and 4B and described below.

The processor 114 may obtain the historical trip and charging information associated with the vehicle 102 (as shown by a block 402) and determine the primary parking location for the vehicle 102 based on the obtained information (as shown by a block 404). The processor 114 may then tag the identified location as the primary parking location, as shown by a block 406. The processor 114 may then correlate the identified primary parking location with the user inputs including the home address (if available) or determine the vehicle's parking behavior during night time, as shown by a block 408. The processor 114 may tag the identified primary parking location as the home location when the home address matches with the primary parking location, and/or when the vehicle 102 regularly parks at the primary parking location during night time, as shown by a block 410. The processor 114 may alternatively tag the identified primary parking location as primary fleet parking location if the vehicle 102 is a fleet vehicle, as shown by a block 412.

If the processor 114 is not able to tag or identify a vehicle's primary parking location, the processor 114 may check the most common hours at which the vehicle 102 was parked at each location (as shown by a block 414), and then tag a location as a home location if the location is in a residential area and the vehicle 102 was parked at the location during night time on weekdays (as shown by a block 416). Further, the processor 114 may tag a location as a “likely” work location if the location is in a commercial area and the vehicle 102 was parked at the location during day time on weekdays (as shown by a block 418).

The processor 114 may further calculate number of weekly visits to the location that is tagged as likely work location and the number of weekly hours spent by the vehicle 102 at the likely work location to check for the primary work details, as shown by a block 420. If the location is a high ranking likely work location (i.e., has a high confidence level), the processor 114 may check for location/parking tag (as shown by a block 422) and tag the location as “Work from home” if the location is the vehicle's home location/address (as shown by a block 424). The processor 114 may alternatively tag the location as “Primary Work” location if the location is not the vehicle's home location/address, as shown by a block 426. In additional aspects, the processor 114 may abort the process of tagging the work location (as shown by a block 428) if the location is not a high ranking likely work location.

Similar to the tagging of the primary parking location as described above, the processor 114 may analyze and tag the vehicle's charging locations (or the chargers 110), as depicted in FIGS. 4A and 4B and described below.

The processor 114 may first compute charging clusters from vehicle's charging events based on the historical charging information, as shown by a block 430. The processor 114 may further track the charger levels of all charging events happening at the charging cluster (as shown by a block 432), and tag a charger as AC charger if no Level 3 charging has occurred (as shown by a block 434) and tag a charger as DC charger if Level 3 charging has occurred (as shown by a block 436).

The processor 114 may further analyze the charging cluster data (as shown by a block 438) and correlate it with data included in a public charger database (as shown by a block 440). If a match is made based on the correlation, the processor 114 may tag public/private charger based on the access type (as shown by a block 442). Alternatively, if a match is not made, the processor 114 may track distinct vehicle visits at charge cluster (as shown by a block 444), and tag a charger as a residential charger if the charger is located at a residential geospatial area and the vehicle 102 made less than 5 distinct visits to the charger (as shown by a block 446). Alternatively, the processor 114 may tag the charger as not being in the public charger database (as shown by a block 448).

In this manner, the processor 114 may tag the parking locations and the chargers 110 (or charging locations) associated with the vehicle 102 based on the vehicle's historical trip and charging information. Such tagging information for a plurality of vehicles may be used by utility power firms and/or charger management firms to optimize charging experience for vehicle users (e.g., by installing more chargers at a geographical area where a lot of “primary locations” for vehicles are present).

The vehicles 102 and the system 104 implement and/or perform operations, as described here in the present disclosure, in accordance with the owner manual and safety guidelines. In addition, any action taken by the vehicle users should comply with all the rules specific to the location and operation of the vehicles 102 (e.g., Federal, state, country, city, etc.). The notifications/recommendations, as provided by the vehicles 102 or the system 104, should be treated as suggestions and only followed according to any rules specific to the location and operation of the vehicles 102.

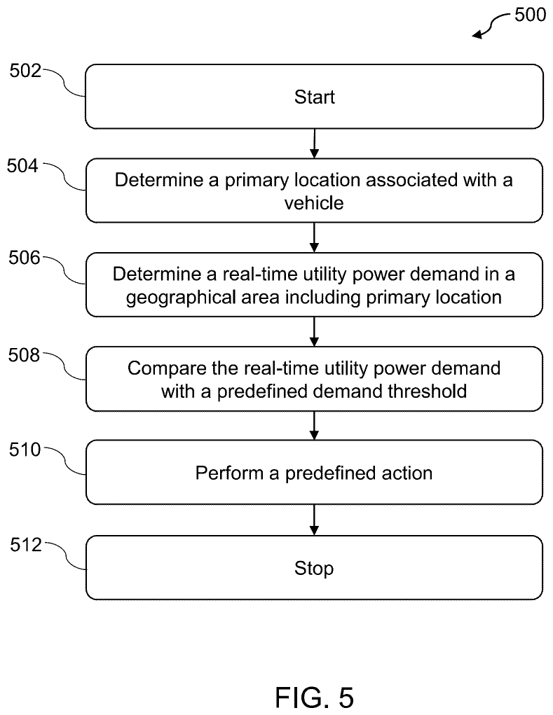

FIG. 5 depicts a flow diagram of an example method 500 for optimizing vehicle charging based on a vehicle's primary location in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include determining, by the processor 114, a primary location, from the plurality of locations 108, associated with the vehicle 102 based on the historical trip information and the historical charging information. At step 506, the method 500 may include determining, by the processor 114, a real-time utility power demand in a geographical area including the primary location, when the vehicle 102 is located at the primary location.

At step 508, the method 500 may include comparing, by the processor 114, the real-time utility power demand with a predefined demand threshold. At step 510, the method 500 may include performing, by the processor 114, the predefined action when the real-time utility power demand is greater than the predefined demand threshold. The examples of the predefined action are described above.

The method 500 may end at step 512.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a transceiver configured to receive a historical trip information and a historical charging information associated with a vehicle; and
a processor configured to:
determine a primary location, from a plurality of locations, associated with the vehicle based on the historical trip information and the historical charging information, wherein the plurality of locations is historically visited by the vehicle;
determine a real-time utility power demand in a geographical area comprising the primary location, when the vehicle is located at the primary location;
compare the real-time utility power demand with a predefined demand threshold; and
perform a predefined action when the real-time utility power demand is greater than the predefined demand threshold.

2. The system of claim 1, wherein the transceiver receives the historical trip information and the historical charging information from a server.

3. The system of claim 1, wherein the historical trip information comprises location information of the plurality of locations at which the vehicle was historically parked, a count of times the vehicle was parked at each location and time durations for which the vehicle was parked at each location of the plurality of locations.

4. The system of claim 3, wherein the location information of the plurality of locations is identified based on historical Global Positioning System (GPS) information associated with the vehicle.

5. The system of claim 1, wherein the historical charging information comprises charging location information of one or more charging locations, from the plurality of locations, at which the vehicle was historically charged, a count of times the vehicle was charged at each charging location and charging time durations of the vehicle at each charging location of the one or more charging locations.

6. The system of claim 1, wherein the processor is further configured to determine a primary parking location associated with the vehicle based on the historical trip information, and wherein the primary parking location is a location where the vehicle historically parked for a highest time duration or for a highest count of times.

7. The system of claim 1, wherein the processor is further configured to determine a primary charging location associated with the vehicle based on the historical charging information, and wherein the primary charging location is a location where the vehicle historically charged for a highest time duration or for a highest count of times.

8. The system of claim 1, wherein the historical trip information and the historical charging information associated with the vehicle are for a predefined historical time duration.

9. The system of claim 8, wherein the processor is further configured to:
determine one or more first locations, from the plurality of locations, at which parking frequencies associated with the vehicle were greater than a predefined threshold based on the historical trip information; and
determine the primary location from the one or more first locations.

10. The system of claim 9, wherein the predefined threshold is once a week.

11. The system of claim 9, wherein the processor is further configured to:
determine a first total time duration for which the vehicle was parked at each of the one or more first locations based on the historical trip information;
determine a first count of times the vehicle was parked at each of the one or more first locations based on the historical trip information; and
determine a primary park confidence level associated with each of the one or more first locations based on the first total time duration and the first count of times.

12. The system of claim 11, wherein the processor is further configured to:
determine a second total time duration for which the vehicle was charged at each of the one or more first locations based on the historical charging information, when the predefined historical time duration is greater than a predefined time duration threshold;
determine a second count of times the vehicle was charged at each of the one or more first locations based on the historical charging information, when the predefined historical time duration is greater than the predefined time duration threshold; and
determine a primary plug confidence level associated with each of the one or more first locations based on the second total time duration and the second count of times.

13. The system of claim 12, wherein the processor is further configured to:
calculate a primary confidence level associated with each of the one or more first locations based on at least one of the primary park confidence level or the primary plug confidence level for respective first locations; and
determine the primary location, from the one or more first locations, based on the primary confidence level associated with each of the one or more first locations.

14. The system of claim 13, wherein the processor is further configured to:
determine a first potential candidate location from the one or more first locations such that the primary confidence level associated with the first potential candidate location is highest amongst primary confidence levels associated with the one or more first locations; and
select the first potential candidate location to be the primary location for the vehicle.

15. The system of claim 14, wherein the processor is further configured to:
determine a second potential candidate location from the one or more first locations such that the primary confidence level associated with the second potential candidate location is second highest amongst the primary confidence levels associated with the one or more first locations;
calculate a first difference between a count of times the vehicle was parked at the first potential candidate location and a count of times the vehicle was parked at the second potential candidate location based on the historical trip information;
calculate a second difference between a total time duration the vehicle was parked at the first potential candidate location and a total time duration the vehicle was parked at the second potential candidate location based on the historical trip information; and
select the first potential candidate location to be the primary location for the vehicle when the first difference is greater than a first predefined threshold and the second difference is greater than a second predefined threshold.

16. The system of claim 1, wherein the predefined action comprises at least one of: transmitting a command signal to the vehicle to autonomously move the vehicle to a second location that is different from the primary location, outputting a first notification comprising a request to move the vehicle to the second location, outputting a second notification comprising one or more incentives to be offered to a vehicle user when the vehicle user moves the vehicle to the second location, outputting a third notification comprising a request to not charge the vehicle at the primary location at a current time, or outputting a command signal to the vehicle plugged in at the primary location to automatically stop charging during windows of high energy demand and resume the charging outside of the windows of high energy demand.

17. The system of claim 1, wherein the predefined action comprises outputting a notification to a server associated with a charger management firm, wherein the notification comprises a request to install one or more new chargers at the primary location.

18. The system of claim 1, wherein the processor is further configured to:
obtain user inputs associated with a home location of the vehicle;
correlate the primary location with the home location based on the user inputs; and
tag the primary location as the home location when the primary location matches with the home location.

19. A method comprising:
determining, by a processor, a primary location, from a plurality of locations, associated with a vehicle based on a historical trip information and a historical charging information of the vehicle, wherein the plurality of locations is historically visited by the vehicle;
determining, by the processor, a real-time utility power demand in a geographical area comprising the primary location, when the vehicle is located at the primary location;
comparing, by the processor, the real-time utility power demand with a predefined demand threshold; and
performing, by the processor, a predefined action when the real-time utility power demand is greater than the predefined demand threshold.

20. A non-transitory computer-readable storage medium having instructions stored thereupon which, when executed by a processor, cause the processor to:
determine a primary location, from a plurality of locations, associated with a vehicle based on a historical trip information and a historical charging information of the vehicle, wherein the plurality of locations is historically visited by the vehicle;
determine a real-time utility power demand in a geographical area comprising the primary location, when the vehicle is located at the primary location;
compare the real-time utility power demand with a predefined demand threshold; and
perform a predefined action when the real-time utility power demand is greater than the predefined demand threshold.
